(19) United States
(12) Patent Application Publication
(10) Pub. No.: US 2004/0257974 A1
(43) Pub. Date: Dec. 23, 2004

(54) Structure for color digital versatile disk

(76) Inventor: Ming-Te Lai, Lujhou City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/636,705

(22) Filed: Aug. 8, 2003

(30) Foreign Application Priority Data
Jun. 19, 2003 (TW) 092211213

(51) Int. Cl. G11B 3/70; G11B 5/84; G11B 7/26

(52) U.S. Cl. 369/286

(57) ABSTRACT

A color digital versatile disk (DVD) structure discloses that an optically opacity top laminate is bonded to a bottom laminate which is with a reflective layer, a recording layer, and a substrate. The bottom laminate uses molding injection process with an optically opacity pigment and a plastic material to shorten process time. Furthermore, the different colors in top laminate pair with the color in the storage layer of the bottom laminate by using optical opacity, and the presented color in storage medium can show any of the colors.

### BACKGROUND OF THE INVENTION

1. Field of the Invention

The present invention relates to a color digital versatile disk (DVD) structure. More particularly, it discloses that a color top laminate is bonded to the bottom laminate to reform a color digital versatile disk, and which brand names, standard or recording data can directly be printed on the surface of the layer.

2. Description of the Related Art

Conventionally, different kinds of plastic dye art are widely used in color versatile disk. For examples, luminous dye, PC painting, or liquid dye are widely used to produce the color versatile disks. To overview the present versatile disks, they still use laser-transparent dye materials to store wavelength, and then the color is coated on the substrate or the data disk of the compact disk. The series of products using this technique include CD, CD-R, CD-RW, DVD, DVD-R, DVD-RW, and DVD-RAM. However, all of the color disks need to go through printing process to label the product content, mark the brand names, or show the product style. Please referring to Taiwan Patent No. 452790, it discloses a color versatile disk and its manufacturing method, which substrate is a color transparent layer.

Apart from above, the general DVD structure can be seen from FIG. 1, which illustrates a prior art of DVD structure. The structure of the traditional digital versatile disk 1′ as shown in Figure includes a top laminate 10′ and a bottom laminate 20′. The bottom laminate comprises of a substrate 22′, a storage layer 24′, and a reflective layer 26′.

The substrate 22′ is on the bottom of versatile disk (polished side), and is the base of the digital versatile disk 1′. It has a responsibility to support the whole disk and transmittance laser beam. The 1.2 mm (0.12 cm) thickness of material is made of optical polycarbonate. The storage layer 24′ is the place for storing data, and its material is usually made of Al, Gold, and Cu for reflecting lasers signals. The thickness of this layer is only 10-7 mm. The top laminate 10′ is to protect the reflective layer 26′ against oxidation etching, and is the bottom color side for printing. Firstly, the top laminate 10′ is coated with a bottom color layer 12′, and then using screen or plain printing to print the figures on the disk.

In the traditional method of digital versatile disk (DVD) manufacturing process, texts and figures are printed on DVD after using printing technique to coat a bottom color layer 12′ on the top laminate 10′ of digital versatile disk (DVD). This leads the printing time and ink cost increase.

In order to overcome the above problem, a novel color digital versatile disk structure is invented here. It can overcome the shortage of using an extra printing by a bottom color layer on the top laminate. The users and inventors have expected the improved method for years. Inventors of this invention put many efforts to do research on storage medium with his many experiences of products research, development, and sales, and finally an improved structure is provided in this invention. Thus, the structure disclosed herein provides significant benefits over prior-art techniques and devices.

### SUMMARY OF THE INVENTION

It is an object of the present invention to provide a color digital versatile disk structure, which uses an optical opacity dye material to add into a plastic material. For example, by using an injection molding method with PC, PMMA, PS, PE, or PP material to produce an optical opacity top laminate. Then, the top laminate and the bottom laminate are bonded together, which omit an extra printing of bottom color layer in the process. The printing time and ink cost therefore decrease.

It is another object of the present invention to provide a color digital versatile disk structure with an optical opacity top laminate to shorten the manufacturing process and decrease the producing cost. The optical opacity top laminate can be any of the colors, and pairs with the color of the bottom laminate to provide a color digital versatile disk (DVD). This can enhance the quality of the product and products variety, and can have better competition ability.

In order to achieve the purpose and the advantage described above, the present invention is to provide a color digital versatile disk (DVD), and uses the feature of an optical opacity of the top laminate to bond with the bottom laminate of which with a reflective layer, a storage layer, and a substrate. The top laminate here uses an injection molding process with an optical opacity dye material and a plastic material to shorten the manufacturing process. Furthermore, the different colors in top laminate pair with the color in the storage layer of the bottom laminate by using optical opacity, and the presented color in storage medium can show any of the colors.

It is to be understood that both the foregoing general description and the following detailed description are exemplary, and are intended to provide further explanation of the invention as claimed.

### BRIEF DESCRIPTION OF THE DRAWINGS

The accompanying drawing is included to provide a further understanding of the invention, and is incorporated in and constitutes a part of this specification. The drawing illustrates an embodiment of the invention and, together with the description, serves to explain the principles of the invention. In the drawing,

FIG. 1 shows a digital versatile disk structure as a prior art;

FIG. 2 is a preferred embodiment of the present invention showing a color digital versatile disk structure;

FIG. 3 is another preferred embodiment of the present invention showing a color digital versatile disk structure; and

FIG. 4 is another preferred embodiment of the present invention showing a color digital versatile disk manufacturing flow chart.

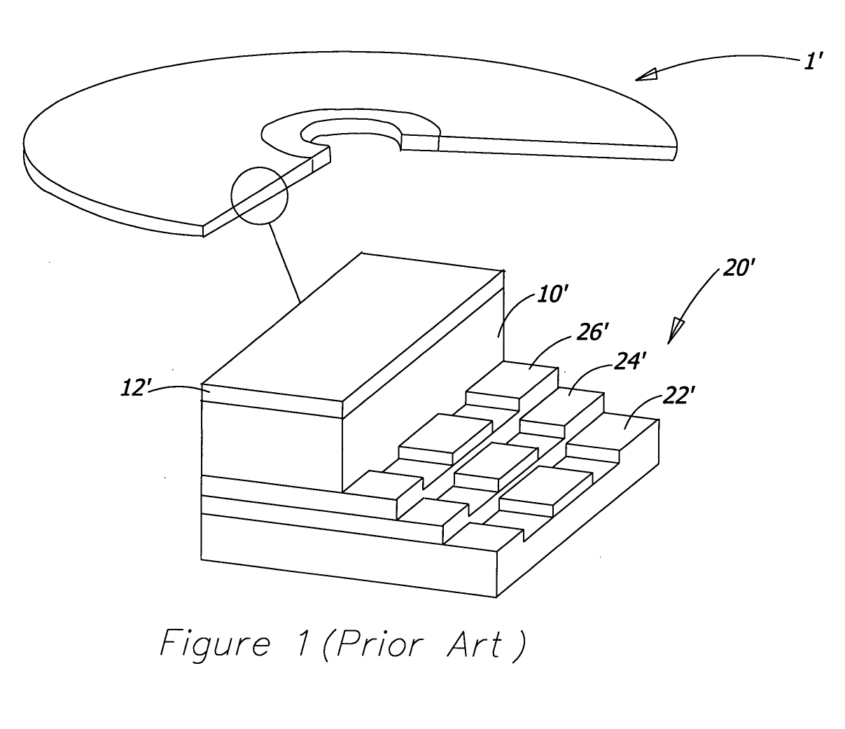

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The present invention uses an optical opacity top laminate structure to replace traditional method of a top laminate with an extra step of printing a bottom color layer. This effectively shortens printing process, decreases ink cost, and further improves the DVDs surface quality. Besides, by matching with different colors from the top laminate and bottom laminate, it has various color forms.

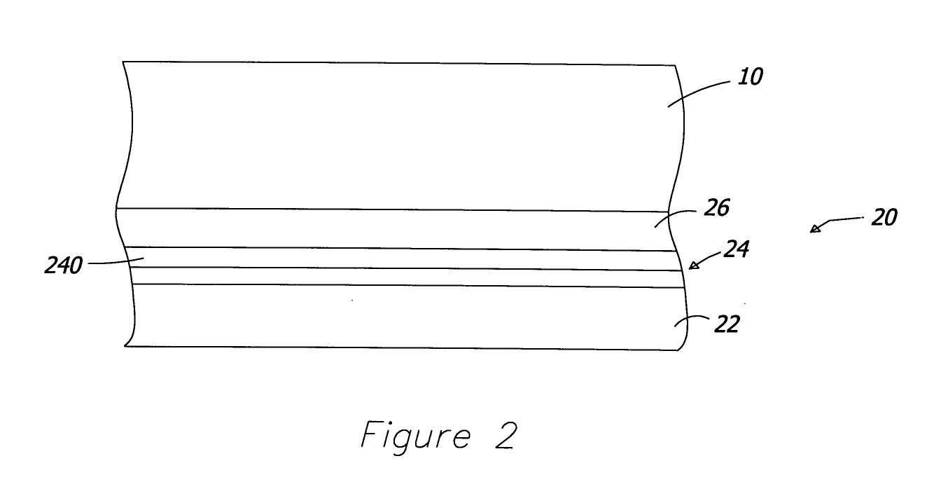

Referring to FIG. 2, it is a cross-sectional view of a color digital versatile disk structure showing one of the preferred embodiments in the present invention.

The color digital versatile disk structure of the present invention comprises a top laminate 10, a bottom laminate 20. The top laminate 10 is bonded to the bottom laminate 20, and color match in the top laminate 10 and the bottom laminate 20 is also implemented to reform a color digital versatile disk. Any data descriptions can be directly printed in the top laminate 10 without an extra printing of bottom color layer as mentioned in traditional DVDs structure.

The bottom layer 20 of the present invention includes a substrate 22, a storage layer 24, and a reflective layer 26. The storage layer 24 is on the substrate 22, and the reflective layer 26 is on the storage layer.

The top laminate 10 uses an injection molding method with PC, PMMA, PS, PE, or PP material to reform a 6 mm of non-grooved signal disk, which is to keep enough thickness and disk's strength without recording functions. Apart from the top laminate 10, the bottom laminate 20 was injected by pre-grooved signals on stamper, and then uses DVDs injection molding technique to reprint grooved signals into the DVDs substrate of PC or PMMA materials. After that, using the function of the optical grooved substrate to reform a pre-recorded DVD with a reflective layer. Or using the optical grooved substrate to sputter the recording dye (in DVD manufacturing process), or sputtering magnetic metal storage layer (DVD-RW manufacturing process) to sputter it on the reflective layer 26. Finally it is bonded to the top laminate to reform a digital versatile disk.

The organic dye layer 240 in this present invention covered with the reflective layer (26, which can be said as a plain Al piece). The variety of dye pigment reforms different colors, such as gold, blue, green, and other kinds of disks. The top laminate 10 with various colors pairs with the bottom laminate 2) to reform a variety of color match.

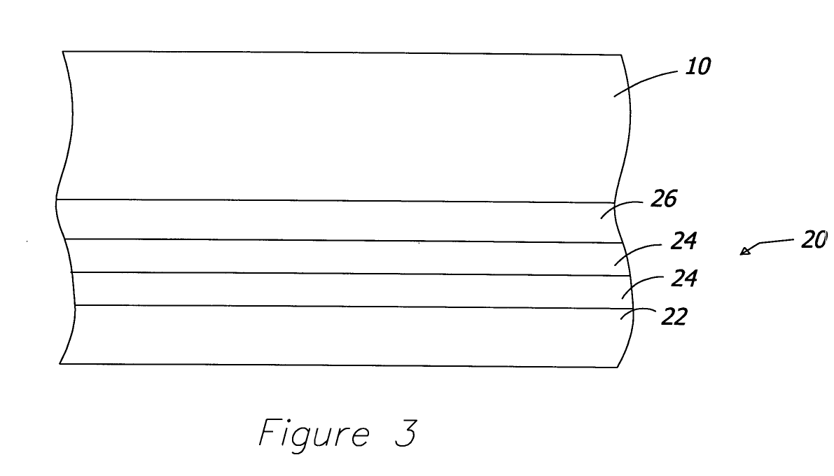

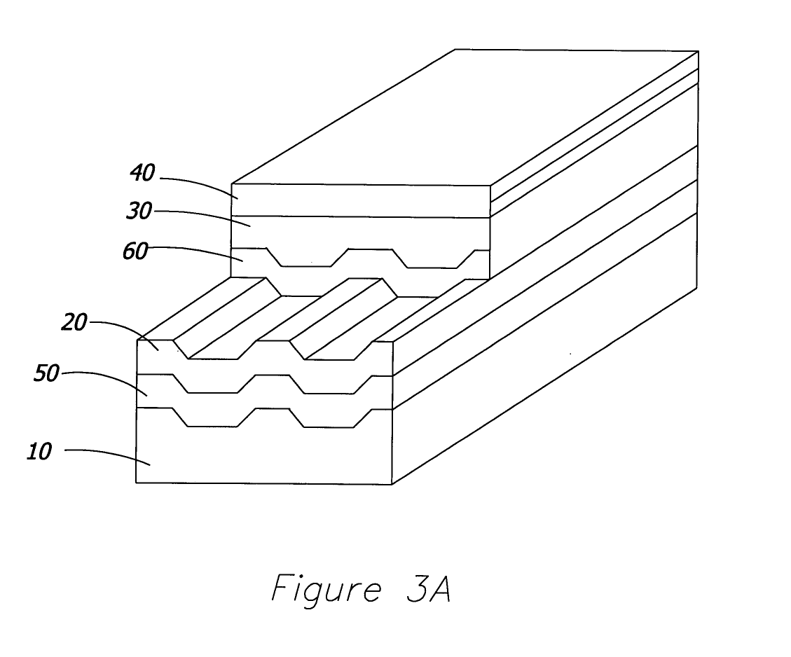

Referring to FIG. 3, it is another preferred embodiment of the present invention showing a storage medium structure.

The storage layer in FIG. 3 has a dual-layer. The standard is not one type, instead, it has four types, which are single side/single layer, single side/dual layer, dual side/dual layer. After producing a dual-side versatile disk, the storage layer 24 can be still designed as a dual-layer. The versatile disk is produced according to different capacities, and the substrate 22 and reflective layer 26 are bonded to the top laminate 10 finally.

The below is a preferred embodiment by using a white dye as a dye pigment of the top laminate. The present invention provides a color digital versatile disk as a utility model.

The color digital versatile disk provided in the present invention is to use white luminous dye, other color dye, or other color paste to coat on the top laminate of the DVD. The top laminate with white or other opacity color is reformed by injection molding. The purpose of producing color top laminate with white or other opacity is to replace the traditional digital versatile disk process of extra bottom color printing. The figures and the texts are directly printed on white or other color opacity top laminate after bonding. In the traditional method of digital versatile disk (DVD) manufacturing process, texts and figures are printed on DVD after using printing technique to coat a bottom color layer 12′ on the top laminate 10′ of digital versatile disk (DVD). In the present invention, the white dye, other color dye or other color paste added in the disk is a called smoky white powder additive, which is directly used or mixed with color dye to reform an opacity dye. This kind of white powder usually is TiO2, SiO2, CaCO3, MgO, Al(OH)3, PMMA, MS, PS, other inorganic and organic series of plastic white additive. The purpose is against light beam of which reforms the white substance on the top laminate.

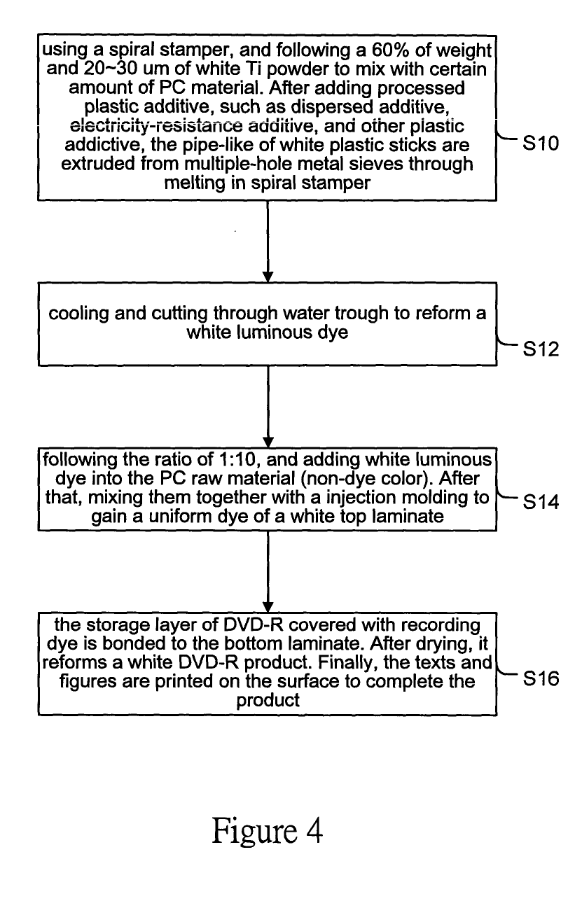

The below description explains another preferred embodiment of manufacturing method, which uses luminous dye method to produce a white digital versatile disk. Referring to FIG. 4, it is a preferred embodiment showing a color DVD manufacturing flow chart.

As can be seen from the figure, the steps are as follows;

Step S10, using a spiral stamper, and following a 60% of weight and 20˜30 um of white Ti powder to mix with certain amount of PC material. After adding processed plastic additive, such as dispersed additive, electricity-resistance additive, and other plastic addictive, the pipe-like of white plastic sticks are extruded from multiple-hole metal sieves through melting in spiral stamper;

Step S12, cooling and cutting through water trough to reform a white luminous dye;

Step S14, following the ratio of 1:10, and adding white luminous dye into the PC raw material (non-dye color). After that, mixing them together with a injection molding to gain a uniform dye of a white top laminate; and

Step S16, the storage layer of DVD-R covered with recording dye is bonded to the bottom laminate. After drying, it reforms a white DVD-R product. Finally, the texts and figures are printed on the surface to complete the product.

The present invention uses an optical opacity top laminate structure to overcome traditional problem of a top laminate with an extra step of printing a bottom color layer. After that, figures and texts which present products' brand names, standard or recording data are directly printed on the surface of the layer. The present invention uses an injection molding with an opacity dye and a plastic material to produce a color top laminate. Then, the top laminate is bonded to the bottom laminate of which includes a substrate, a storage layer, and a reflective layer, such as Gold, Green, Blue, and etc. The top laminate 10 with various colors pairs with the bottom laminate 20 to reform a variety of color match, and then completing an invention of a color digital versatile disk. This shortens the manufacturing process and decreases the producing cost. Also, it enhances the quality and product variety.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A color digital versatile disk structure comprising:
a top laminate being an optical opacity layer; and
a bottom laminate deposited below the top laminate, comprising;
a substrate;
a storage layer deposited on said substrate; and
a reflective layer deposited on said storage layer;
wherein said top laminate and the said bottom laminate are bonded together to reform a color versatile disk.

2. The color digital versatile disk structure according to claim 1, wherein said top laminate chooses one of the materials from PC, PMMA, PS, PE, PP or other transparently plastic materials.

3. The color digital versatile disk structure according to claim 1, wherein said the surface of top laminate can be directly printed by brand names, standard or recording data.

4. The color digital versatile disk structure according to claim 3, wherein said printing is screen printing.

5. The color digital versatile disk structure according to claim 1, wherein said storage layer can be dual-layer.

6. The color digital versatile disk structure according to claim 1, wherein said storage medium can apply to data storage, image, voice, or video systems.
